(19) United States
(12) Patent Application Publication
(10) Pub. No.: US 2007/0013717 A1
(43) Pub. Date: Jan. 18, 2007

(54) Displaying non-linear images on linear displays

(76) Inventor: Jeffrey Matthew Kempf, Dallas, TX (US)

Correspondence Address: TEXAS INSTRUMENTS INCORPORATED, P O BOX 655474, M/S 3999, DALLAS, TX, 75265, US

(21) Appl. No.: 11/180,751

(22) Filed: Jul. 13, 2005

(51) Int. Cl. G09G 5/02

(52) U.S. Cl. 345/596

(57) ABSTRACT

System and method for gray scale mapping for displaying non-linear images on linear displays. A preferred embodiment comprises applying a linearizing function to a non-linear image to produce a linear image, selecting a picture element in the linear image, determining a first gray shade and a second gray shade based upon the picture element, computing a dither percentage, and selecting either the first gray shade or the second gray shade based upon the dither percentage and a threshold value. The dithering can reduce the presence of contouring, which reduces image quality, while non-linear spacing between gray shades permits the optimization of pulse width modulation sequences to reduce transition artifacts.

### TECHNICAL FIELD

The present invention relates generally to a system and method for image display systems, and more particularly to a system and method for displaying non-linear images on linear displays.

### BACKGROUND

Cathode ray tube (CRT) based displays have a nonlinear response. Therefore, to properly display images, a non-linear transfer function is applied to images prior to display on CRT based displays. This non-linear transfer function is commonly referred to as a gamma correction curve. Since CRT based displays dominate the market, the non-linear transfer function is automatically applied to many images and video streams (broadcast television and video from videocassette tape and DVD, for example).

In order to properly display the transformed images and video streams on a linear display, such as a display based on a spatial light modulator (SLM) like a digital micromirror device (DMD), a liquid crystal display (LCD), liquid crystal on silicon (LCOS), and so forth, a reverse transfer function (commonly referred to as a de-gamma curve) must be applied to the transformed images and video streams.

The application of the de-gamma curve will remove the non-linear transform applied to the images and video streams and will permit the display of the images and video streams on linear displays without distortion. However, the application of the de-gamma curve requires a high level of bit precision to yield acceptable image quality since an inadequate level of bit precision can lead to contouring. Contouring is a quantization artifact that appears as discrete jumps in images with areas that are, in actuality, smoothly varying. For example, images with shadows will appear to have bands within the shadows rather than a continuously varying shadow.

Dithering is a commonly used prior art technique to help improve image quality without requiring an increase in available bit precision. Dithering simulates a shade that is not producible by combining shades that are producible. Combinations of producible shades in predetermined proportions simulate the non-producible shade.

One disadvantage of the prior art is that the application of the de-gamma curve requires a high level of bit precision in order to prevent the occurrence of contouring. Many SLM-based display systems do not have adequate bit precision to prevent contouring. This can lead to an unacceptable image quality.

A second disadvantage of the prior art is that conventional dithering techniques, such as error diffusion dithering, requires that a distance between adjacent displayable shades throughout a display range be equally spaced. However, with a spatial light modulator based display making use of pulse width modulation (PWM), overall performance can be optimized if this is not required. Therefore, conventional dithering techniques do not provide optimal performance in SLM-based displays.

### SUMMARY OF THE INVENTION

These and other problems are generally solved or circumvented, and technical advantages are generally achieved, by preferred embodiments of the present invention which provides a system and method for gray scale mapping for linear displays.

In accordance with a preferred embodiment of the present invention, a method for displaying a non-linear image on a linear display is provided. The method includes applying a linearizing function to the non-linear image to produce a linearized image, selecting a picture element in the linearized image, determining a first gray shade and a second gray shade both based upon the picture element. The method also includes computing a dither percentage and selecting either the first gray shade or the second gray shade to display based upon a comparison of the dither percentage and a threshold value.

In accordance with another preferred embodiment of the present invention, a circuit is provided. The circuit includes a de-gamma correction unit (DCU) coupled to a video signal input, with the DCU being configured to remove a non-linear transformation present in images in the video signal from the video signal input, and a gray shade unit (GSU) coupled to the DCU, with the GSU being configured to provide a first displayable gray shade with an intensity immediately above an intensity of a gray shade of a picture element in an image in the video signal and a second displayable gray shade with an intensity immediately below the intensity of the gray shade of the picture element. The circuit also includes a dithering unit coupled to the GSU and the DCU, with the dithering unit being configured to compute a dither percentage based upon the gray shade of the picture element, the first displayable gray shade, and the second displayable gray shade, and to select the first displayable gray shade or the second displayable gray shade based upon the dithering percentage and a threshold value.

In accordance with another preferred embodiment of the present invention, a display system is provided. The display system includes a gray scale mapping engine (GSM) coupled to a signal input, with the GSM being configured to produce a linear output image from a non-linear input image provided by the signal input, and a display device coupled to the GSM, with the display device being configured to display the linear output image. The linear output image is dithered using non-linear dithering to prevent contouring.

An advantage of a preferred embodiment of the present invention is that there is no longer a requirement that the gray shades are equally spaced. This can permit the optimization of image quality in SLM-based display systems.

A further advantage of a preferred embodiment of the present invention is that the number of gray shades can be reduced. This implies that the number of PWM transitions will also be reduced. Since transitory display artifacts occur across PWM transitions, reducing the number of transitions will also reduce the number of display artifacts.

Yet another advantage of a preferred embodiment of the present invention is that arbitrary bit weightings can be used, rather than requiring a binary bit weighting. This can lead to a more flexible PWM sequence design with further possible optimization.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1a and 1b are diagrams of the display of gamma corrected images and video signals on a non-linear display and a linear display;

FIG. 2 is a diagram of a gray scale mapping engine for linear displays for displaying gamma corrected images and video signals, according to a preferred embodiment of the present invention;

FIG. 3 is a diagram of a detailed view of a dithering unit, according to a preferred embodiment of the present invention;

FIGS. 4a through 4c are diagrams of the determination of displayable gray shades from gray shades that are based on original pixel values using a threshold array for dithering purposes, according to a preferred embodiment of the present invention;

FIG. 5 is a diagram of an algorithm used in the determination of displayable gray shades from gray shades based on original pixel values, according to a preferred embodiment of the present invention; and

FIG. 6 is a diagram of a display system with a gray scale mapping engine, according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a video display system using a digital micromirror device (DMD) spatial light modulator. The invention may also be applied, however, to other video display systems with linear responses, such as other SLM-based systems, including LCD, LCoS, deformable mirror based display systems and non-SLM-based systems with a limited bit precision.

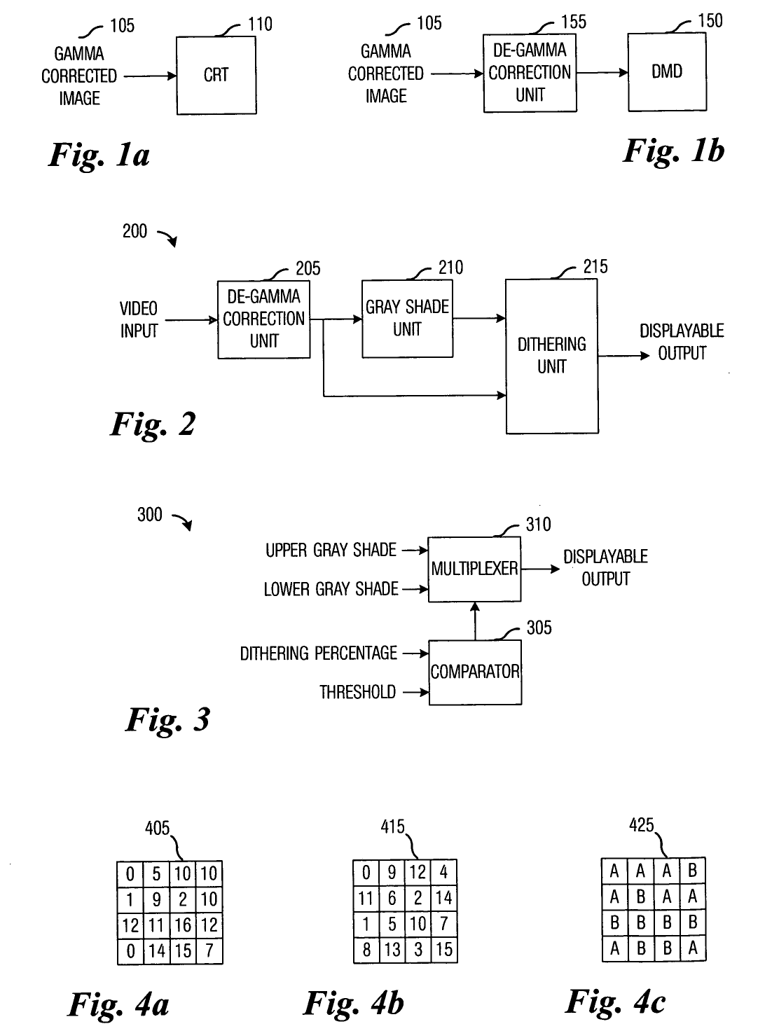

With reference now to FIGS. 1a and 1b, there are shown diagrams illustrating the display of gamma corrected images and video signals on a non-linear and a linear display. The diagram shown in FIG. 1a illustrates the display of a gamma corrected image 105 on a non-linear display 110, such as a CRT. As long as the gamma correction is properly matched with the behavior of the CRT 110, the gamma corrected image 105 will display as intended on the CRT 110. If the gamma correction is not properly matched with the behavior of the CRT 110, then the gamma corrected image 105 may not display properly.

For proper display on a display that has linear behavior, the gamma corrected image 105 must undergo a reverse operation to remove the gamma correction. The diagram shown in FIG. 1b illustrates the display of the gamma corrected image 105 on a linear display 150, such as a DMD. The gamma corrected image 105 can be provided to a de-gamma correction unit 155 to reverse the effects of the gamma correction. The de-gamma correction unit 155 removes the non-linear transfer function of the gamma correction so that the image can be properly displayed on the DMD 150.

The de-gamma correction operation performed by the de-gamma correction unit 155 can require a high degree of precision in order to prevent contouring, which are quantization artifacts visible as discrete jumps in shades in an image that originally had smooth shade transitions. However, an SLM-based display device will typically have a level of precision that is inadequate to prevent the occurrence of contouring. For example, a typical DMD display system can produce between 256 (eight bits of precision) to 1024 (ten bits of precision) distinct gray shades. To prevent contouring, 14 to 16 bits of precision (16384 to 65536 distinct gray shades) is normally needed. Clearly, typical DMD display systems do not have adequate precision to prevent contouring.

Dithering is a prior art technique that can be used to reduce the visible effects of contouring. However, dithering techniques, such as error diffusion dithering, requires that the spacing between distinct gray shades remain constant throughout the entire range of gray shades. But, PWM (the signaling technique used to provide control data information to the SLM in order to display the images in the SLM-based display system) performance can be improved if such a constraint is not in place.

With reference now to FIG. 2, there is shown a diagram illustrating a gray scale mapping engine for linear displays (GSM) 200 for use in displaying gamma corrected images and video signals on a linear display, according to a preferred embodiment of the present invention. In a display system, the gray shades displayable can be defined by a minimum amount of light producible by the display system, as well as a contrast ratio and brightness of the display system. For an SLM-based display system, the minimum amount of light producible can be dependent upon a shortest amount of time that a light modulator requires to switch state. For example, if the shortest amount of time required to switch state is 65 micro-seconds and the display system has a contrast ratio of 1000:1 with a brightness of 1000 lumens, then it can be possible to display up to 256 distinct shades of gray.

However, studies of the human visual system have shown that the human eye can discern gray shade changes as small as 1% between gray shades. This is referred to as the just noticeable difference (JND). Using the JND it is possible to display the entire 1000 lumen range with approximately 196 distinct shades of gray. For example, using 256 distinct shades of gray, if the spacing between shades remains constant, there is a separation of 3.9 lumens between each shade. However, at the upper end of the gray shade scale, with the brightest shade of gray being 1000 lumens, the next discernable shade of gray is 1000/1.01=990 lumens. Therefore, the 10 lumen range can be spanned by two shades of gray rather than three. At the lower end of the gray shade scale, the dimmest shade of gray is set at one (1) lumen, then the next discernable shade of gray is 1*1.01=1.01 lumens. Dithering can be used to display the shade of gray corresponding to 1.01 lumens, as well as other shades of gray that are not directly producible by the SLM-based display system.

The GSM 200 comprises a de-gamma correction unit 205 that has an input coupled to a video input. According to a preferred embodiment of the present invention, the video input provides a raw video signal in a red-green-blue (RGB) format. The video input may be able to provide a video signal in other formats, such as Y/UV, and so forth. Although the discussion and the exemplary embodiment of the present invention makes use of an RGB formatted video signal, the present invention can be applicable to other video signal formats and therefore the discussion of the RGB video signal should not be construed as being limiting to the spirit of the present invention. The raw video signal contains sequences of images that have been gamma corrected for proper display on a non-linear display, such as a CRT.

The de-gamma correction unit 205 may be implemented as a look-up table to facilitate a rapid conversion of the images in the video signal. The look-up table can be indexed based upon pixel values in the gamma corrected images and can store values corresponding to original pixel values prior to gamma correction. According to a preferred embodiment of the present invention, the values stored in the look-up table should have adequate resolution (14 to 16 bits) to prevent contouring. Alternatively, the de-gamma correction unit 205 can implement an actual de-gamma correction function and mathematically compute the original pixel values corresponding to gamma corrected values from the images in the video signal. The mathematical implementation of the de-gamma correction function should be configured so that adequate resolution is used to prevent the occurrence of contouring.

Output from the de-gamma correction unit 205 can then be provided to a gray shade unit (GSU) 210 and a dithering unit 215. The GSU 210 can be used to determine an appropriate gray shade for the original pixel values of the images in the video signal. According to a preferred embodiment of the present invention, the GSU 210 can provide two gray shade values, a first gray shade value being a gray shade value displayable by the SLM-based display system that is immediately above a gray shade value based upon the original pixel values, as provided by the de-gamma correction unit 205, (referred to as a gray shade immediately above) and a second gray shade value being a gray shade value displayable by the SLM-based display system that is immediately below the gray shade value based upon the original pixel values (referred to as a gray shade immediately below). If the gray shade value based upon the original pixel values exactly matches a displayable gray shade, then, according to a preferred embodiment of the present invention, the gray shade value based upon the original pixel values can be set as the gray shade value immediately above and a lowest displayable gray shade can be set as the gray shade value immediately below. Alternatively, the gray shade value based upon the original pixel values can be set as the gray shade value immediately below and a highest displayable gray shade can be set at the gray shade immediately above. In yet another alternative embodiment, the gray shade value based upon the original pixel values can be set as both the gray shade value immediately above and the gray shade value immediately below.

According to a preferred embodiment of the present invention, the GSU 210 can be implemented with circuitry, software, or firmware that implements a binary search algorithm. With the binary search algorithm, a sorted list of displayable gray shades can be maintained and used to compare against the gray shade value based upon the original pixel values. The search can then be accomplished by repeatedly dividing the search interval in half. For example, on an initial search attempt, the gray shade value based upon the original pixel values is compared with a gray shade that is in the middle (or substantially in the middle) of the sorted list. If it is smaller, then the search is repeated with the gray shade valued based upon the original pixel values being compared with a portion of the sorted list that is less than the gray shade that is in the middle of the sorted list. If it is larger, then the search is repeated with the gray shade valued based upon the original pixel values being compared with a portion of the sorted list that is greater than the gray shade that is in the middle of the sorted list. The search continues until a match is found or until the portion of the sorted list contains no entries. An advantage of using a binary search is that for a sorted list with a total of N displayable gray shades, a maximum number of comparisons for a given gray shade value based upon the original pixel values is log₂(N). Binary searches are considered to be well understood by those of ordinary skill in the art of the present invention and will not be discussed further herein.

The dithering unit 215 can receive as input from the GSU 210, the gray shade immediately above and the gray shade immediately below values, as well as the gray shade value based upon the original pixel values from the de-gamma correction unit 205. The dithering unit 215 can make a comparison of the gray shade value based upon the original pixel values with the gray shade immediately above and the gray shade immediately below values to determine a dithering required to properly display the gray shade value based upon the original pixel values on the SLM-based display system. Since an SLM-based display system can only display the displayable gray shades, the dithering performed by the dithering unit 215 may require a combination of multiple adjacent pixels for proper effect. According to a preferred embodiment of the present invention, the dithering unit 215 makes use of a threshold array of size K×L to determine the gray shade to display, with K and L being integer values greater than zero (0). The threshold array of size K×L can be applied to a matrix of adjacent pixels, also of size K×L. The threshold array can have various sizes, such as 4×4, 8×8, 16×16, 16×8, 8×4, and so forth. A preferred threshold array size is 32×32.

The threshold array contains a series of threshold values that can be used to select the gray shade value to display (either the gray shade immediately above or the gray shade immediately below) based upon the gray shade value based upon the original pixel values. The threshold values can be determined through experimentation. If the gray shade value based upon the original pixel values is greater than the threshold value, then the dithering unit 215 can select the gray shade immediately below to display for the gray shade value based upon the original pixel value. If the gray shade value based upon the original pixel values is less than or equal to the threshold value, then the dithering unit 215 can select the gray shade immediately above to display for the gray shade value based upon the original pixel value. A readily evident modification to the dithering unit 215 can be to change the selection criterion. For example, rather than simply greater than to select the gray shade immediately below, the criterion can be changed to greater than or equal to and then the criterion for selecting the gray shade immediately above can be changed from less than or equal to into simply less than.

When the image contains more pixels than the threshold array, the threshold array can simply be tiled across the image. For example, if the image is a 64×64 pixel image and the threshold matrix is a 32×32 element array, then the threshold array can be repeated over the entire image four times, arranged in a 2×2 configuration. According to a preferred embodiment of the present invention, the same threshold array is repeated over the image. Additionally, if the threshold array is larger than the image, portions of the threshold array not corresponding to pixels can be ignored. Although it is possible to logically view the dithering operation as overlaying multiple copies of the threshold array over the image, the dithering operation can simply operate on the image (more precisely, the pixels of the image) as it arrives at the GSM 200, in left to right order and from top to bottom (raster scan order).

The dithering unit 215 can produce an output that comprises a sequence of gray shade values that can be produced by the SLM-based display system, one gray shade for each pixel in each image in the sequence of images. The dithering unit 215 may also produce a different gray shade for each of the three color components (R, G, and B) of each pixel.

With reference now to FIG. 3, there is shown a diagram illustrating a detailed view of a dithering unit 300, according to a preferred embodiment of the present invention. The dithering unit 300 shown in FIG. 3 may be an implementation of the dithering unit 215 (FIG. 2). The dithering unit 300 comprises a comparator 305 having two inputs. A first input can be a threshold value used in the selection of an appropriate gray shade and a second input can be a dithering percentage. The dithering percentage can be defined as a percentage difference between the gray shade that is based upon the original pixel value and a span of the gray shade immediately above and the gray shade immediately below the gray shade that is based upon the original pixel value and can be expressed as (A−D)/(A−B) where A is the intensity of the gray shade immediately above, B is the intensity of the gray shade immediately below, and D is the intensity of the gray shade that is based upon the original pixel value (i.e., the output of the de-gamma correction unit 205 (FIG. 2)). The dithering percentage can be computed by a relatively simple circuit and is not shown herein.

The comparator 305 performs the comparison of the dithering percentage and the threshold value and can provide the results of the comparison to a multiplexer 310. For example, the comparator 305 can determine if the dithering percentage is greater than the threshold value. The multiplexer 310 can make use of the result of the comparison to select between one of two inputs to provide at an output. Depending upon the result of the comparison, the multiplexer 310 can provide the gray shade immediately below or the gray shade immediately above to its output.

With reference now to FIGS. 4a through 4c, there are shown diagrams illustrating the determination of displayable gray shades from gray shades that are based on original pixel values using a threshold array for dithering purposes, according to a preferred embodiment of the present invention. The diagram shown in FIG. 4a illustrates an array of pixel values of size 4×4 from an exemplary image. As discussed previously, a preferred array size can be 32×32, however, for illustrative purposes, the array size has been reduced. The array size does not impact the operation of the determination of displayable gray shades. The array shown in FIG. 4a can be a logical representation of the pixels in an image, which as discussed above, can be processed as they arrive at the GSM 200 (FIG. 2).

The array of pixels contains gray shade values that correspond to graphical information pertaining to the pixels. For example, array element 405 contains gray shade value 10, which means that to properly display the pixel contained in array element 405, the SLM-based display system should display gray shade value of 10. However, the SLM-based display system may not be able to display the gray shade value of 10 and may need to perform dithering.

The diagram shown in FIG. 4b illustrates a threshold array. Although shown in FIG. 4b as being the same size as the array of pixels (FIG. 4a), the threshold array does not have to be the same size as the array of pixels. Any difference in size can be overcome through tiling (if the threshold array is smaller than the array of pixels), not using certain portions of the threshold array (if the threshold array is larger than the array of pixels), or so forth. Threshold array element 415 corresponds to array element 405. Threshold array element 415 contains a threshold value of 12. The threshold value can then be compared with the content of array element 405 (gray shade value of 10) to determine which gray shade to display (either the gray shade immediately above or the gray shade immediately below). The comparison of the threshold value (12) with the gray shade value (10) shows that the gray shade value is less than the threshold value.

The diagram shown in FIG. 4c illustrates a gray shade output matrix. The gray shade output matrix displays the gray shade selected (either the gray shade immediately above or the gray shade immediately below) based upon the results of the comparison. A gray shade output matrix element 425 displays the gray shade selected for array element 405. Since the gray shade value (10) is less than the threshold value (12), then according to a preferred embodiment of the present invention, the gray shade immediately above (A) is selected.

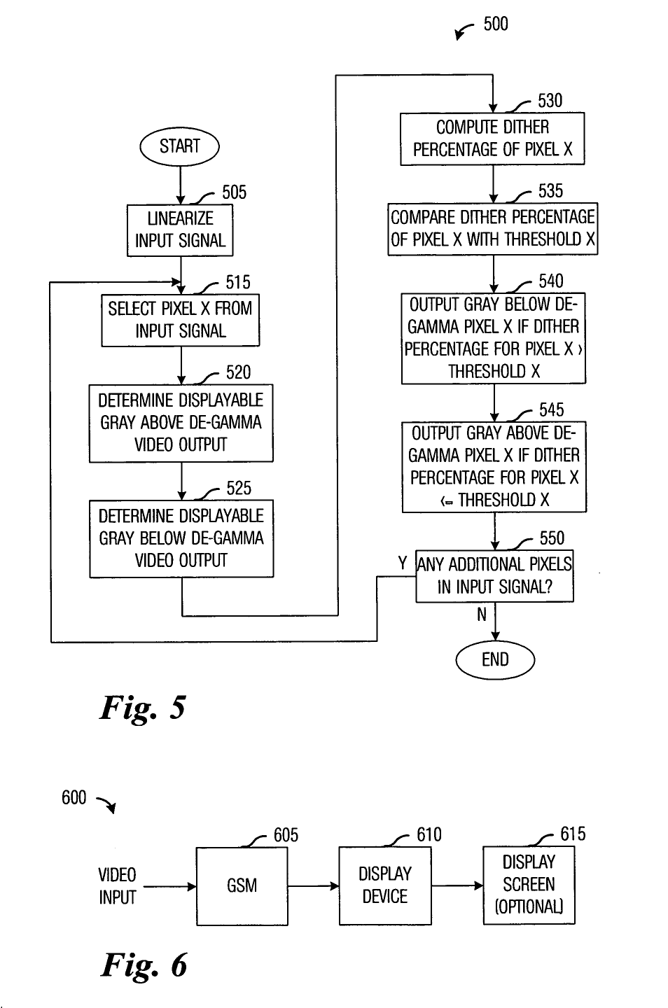

With reference now to FIG. 5, there is shown a diagram illustrating an algorithm 500 for use in the determination of displayable gray shades from gray shades based on original pixel values using a threshold array for dithering purposes for a display system, according to a preferred embodiment of the present invention. According to a preferred embodiment of the present invention, the algorithm 500 can be implemented in specially designed hardware, software, or firmware. Since the determination performed by the algorithm 500 occurs continuously while the display system is displaying images, the algorithm 500 should be designed so that it can automatically start operation once the display system commences operation and should not terminate until the display system is disabled or turned off.

According to a preferred embodiment of the present invention, the algorithm 500 can begin with a de-gamma correction of a video input signal (block 505). Since the video input signal may be a continuous stream, the de-gamma correction of the video input signal can be an operation that can be configured to commence operation and once started, continually operate until stopped. An optional addendum to the de-gamma correction operation can be that a determination of a status of the video input signal can be added. The video input signal can be analyzed to determine if a gamma correction has been applied to the video input signal. If the video input signal has not been gamma corrected, then the de-gamma correction operation can pass the video input signal without performing the de-gamma correction.

The linearization of the video input signal, i.e., the de-gamma correction of the video input signal (block 505) can occur as the video input signal arrives at the GSM 200 (FIG. 2), meaning that it may not be necessary to buffer entire images or sequences of images. The selection of the displayable gray shade can begin with the selection of a pixel X from the video input signal (block 515). The selection of the pixel X may also include the selection of one of the three components (RGB) of the pixel if the SLM-based display system is capable of displaying a single component of a pixel at a time. The value of the selected pixel X (or the value of one of the components of the selected pixel X) can then be used to determine a pair of gray shades that are displayable by the SLM-based display system. A first gray shade, referred to as a gray shade immediately above, determined by the algorithm 500 can be a displayable gray shade that is above the value of the selected pixel X (block 520). A second gray shade, referred to as a gray shade immediately below, determined by the algorithm 500 can be a displayable gray shade that is below the value of the selected pixel X (block 525). According to a preferred embodiment of the present invention, the first gray shade and the second gray shade are gray shades displayable by the SLM-based display system that are the gray shades that most tightly span the value of the pixel X. For example, if the SLM-based display system is capable of displaying gray shades corresponding to values 10, 20, 40, and 80, then if the value of the pixel X is 25, then the first gray shade will correspond to value 40 and the second gray shade will correspond to value 20.

After determining the first gray shade (block 520) and the second gray shade (block 525), then a dither percentage for pixel X can be computed (block 530). The dither percentage can be a ratio of a difference between a displayable gray shade (either the first gray shade or the second gray shade) and the value of the selected pixel X to a difference between the first gray shade and the second gray shade. Either the first gray shade or the second gray shade can be used in determining a difference with the value of the selected pixel X. The use of either the first gray shade or the second gray shade determines a value used in a comparison later in the algorithm 500. The dither percentage can be expressed mathematically as: percentage=(gray shade immediately above−value of selected pixel X)/(gray shade immediately above−gray shade immediately below).

The dither percentage for the selected pixel X can then be compared with a threshold from the threshold matrix that corresponds to the selected pixel X, referred to as threshold X. The threshold X selected can be based upon a position of the selected pixel X in the image being processed. For example, if the selected pixel X is pixel (1, 1) in the image, then the threshold used in the comparison will be located at element (1, 1) of the threshold array. In general, if a pixel is located at pixel (I, J) of the image, then the threshold used in the comparison will be located at element (I modulo K, J modulo L) of the threshold matrix, where K and L are integer values indicating the size of the threshold array. Both the dither percentage and the threshold can be quantized to a specified number of bits. This can help simplify the arithmetic involved in the comparison, permitting the comparison of integer values rather than real values. For example, a dither percentage of 0.50 can be quantized to an eight-bit value by multiplying with 256, with the quantized dither percentage being 0.50×256=128. The quantization can be performed with a binary shift of an appropriate number of bits.

The threshold from the threshold array can then be compared with the dither percentage for the selected pixel X (block 535). If the dither percentage for the selected pixel X is greater than (>) the threshold, then the gray shade immediately below is selected to be output for the selected pixel X (block 540). If the dither percentage for the selected pixel X is less than or equal to (<=) the threshold, then the gray shade immediately above is selected to be output for the selected pixel X (block 545). It can be possible to change the conditions of the comparison performed in blocks 540 and 545. For example, the greater than can be changed to greater than or equal to and the less than or equal to can be changed to strictly less than. Furthermore, if the computation of the dither percentage used a different expression (for example, if the dither percentage was computed as (value of selected pixel X−gray shade immediately below)/(gray shade immediately above−gray shade immediately below)), then the comparison may need to be selecting the first gray shade if the dither percentage is less than or equal to (<=) the threshold and selecting the second gray shade if the dither percentage is greater than (>) the threshold. After selecting the gray shade to be output for the selected pixel X (blocks 540 and 545), then a check can be made to determine if there are any additional pixels in the video input signal that need to be processed (block 550). If there are additional pixels to be processed, then the operation can return to block 515 to select a new pixel X. If there are no additional pixels to be processed, then the operation can terminate.

The following is an example of the operation of the algorithm 500. The de-gamma correction operation yields a value of the selected pixel X to be 352. With a list of displayable gray shades being equal to {0, 4096, 8192, 12288, 16383}, the first gray shade is 4096 while the second gray shade is 0. The dither percentage can then be computed as (4096−352)/(4096−0)=91.4% or (234 quantized to eight bits). If the quantized threshold is 200, then the quantized dither percentage is greater than the quantized threshold, therefore, the gray shade immediately below (the second gray shade) is to be output for the selected pixel X.

With reference now to FIG. 6, there is shown a diagram illustrating a display system 600 with a GSM 200, according to a preferred embodiment of the present invention. The display system 600 includes a gray scale mapping engine (GSM) 605 which can be used to de-gamma correct a video input signal that contains a sequence of gamma corrected images. The GSM 605 can make use of dithering to provide an adequate level of performance (image quality) in a display system with a limited bit precision. The GSM 605 may be similar to the GSM 200 (FIG. 2). The de-gamma corrected images from the GSM 605 can then be provided to a display device 610, such as a spatial light modulator making use of DMD, LCD, LCoS, deformable mirrors, and so forth. The display device 610 can modulate a light source (not shown) to display the images provided by the GSM 605. If the display system 600 is a projection type display system, then an optional display screen 615 can be used to display the images.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for displaying a non-linear image on a linear display, the method comprising:
applying a linearizing function to the non-linear image to produce a linearized image;
selecting a picture element in the linearized image;
determining a first gray shade based upon the picture element;
determining a second gray shade based upon the picture element;
computing a dither percentage; and
selecting either the first gray shade or the second gray to display based upon a comparison of the dither percentage and a threshold value.

2. The method of claim 1, wherein the selecting, the first determining, the second determining, the computing, and the selecting is repeated for remaining picture elements in the linearized image.

3. The method of claim 1, wherein the threshold value is stored in a threshold matrix of size M×N, and wherein the threshold value for a picture element corresponding to location (I, J) of the linearized image is retrieved from a location (I modulo M, J modulo N) of the threshold matrix, where I and J are integer values and M and N are integer values.

4. The method of claim 1, wherein the first determining comprises setting the first gray shade to a displayable gray shade that has an intensity immediately greater than an intensity of a gray shade of the picture element, and wherein the second determining comprises setting the second gray shade to a displayable gray shade that has an intensity immediately less than the intensity of the gray shade of the picture element.

5. The method of claim 4, wherein the first determining comprises setting the first gray shade to the gray shade of the picture element if the gray shade of the picture element is equal to a displayable gray shade, and wherein the second determining comprises setting the second gray shade to a zero intensity gray shade.

6. The method of claim 4, wherein the first determining comprises setting the first gray shade to a maximum displayable gray shade if the gray shade of the picture element is equal to a displayable gray shade, and wherein the second determining comprises setting the second gray shade to the gray shade of the picture element.

7. The method of claim 1, wherein the dither percentage is computed as:
dither percentage=(an intensity of the first gray shade−an intensity of a gray shade of the picture element)/(the intensity of the first gray shade−an intensity of the second gray shade).

8. The method of claim 7, wherein the selecting comprises, selecting the first gray shade if the dither percentage is greater than the threshold value, and selecting the second gray shade if the dither percentage is less than or equal to the threshold value.

9. The method of claim 7, wherein the selecting comprises, selecting the first gray shade if the dither percentage is less than or equal to the threshold value, and selecting the second gray shade if the dither percentage is greater than or equal to the threshold value.

10. The method of claim 1, wherein the dither percentage and the threshold value are quantized to a bit precision of the linear display.

11. The method of claim 1, wherein the dither percentage is computed as:
dither percentage=(an intensity of a gray shade of the picture element−an intensity of the second gray shade)/(an intensity of the first gray shade−the intensity of the second gray shade).

12. A circuit comprising:
a de-gamma correction unit (DCU) coupled to a video signal input, the DCU configured to remove a non-linear transformation present in images in a video signal from the video signal input;
a gray shade unit (GSU) coupled to the DCU, the GSU configured to provide a first displayable gray shade with an intensity immediately above an intensity of a gray shade of a picture element in an image in the video signal and a second displayable gray shade with an intensity immediately below the intensity of the gray shade of the picture element; and
a dithering unit coupled to the GSU and the DCU, the dithering unit configured to compute a dither percentage based upon the gray shade of the picture element and the first displayable gray shade and the second displayable gray shade and to select the first displayable gray shade or the second displayable gray shade based upon the dither percentage and a threshold value.

13. The circuit of claim 12, wherein the DCU comprises a look-up table that is indexed by picture element information with the non-linear transformation.

14. The circuit of claim 12, wherein the GSU comprises a sorted list of displayable gray shades and the first displayable gray shade and the second displayable gray shade are found using a binary search.

15. The circuit of claim 12, wherein the dithering unit comprises:
a comparator configured to compare the dither percentage with the threshold value; and
a multiplexer coupled to the comparator, the multiplexer having a first input coupled to a signal line providing the first displayable gray shade and a second input coupled to a signal line providing the second displayable gray shade, the multiplexer to selectively couple either the first input or the second input to an output based upon a signal provided by the comparator.

16. A display system comprising:
a gray scale mapping engine (GSM) coupled to a signal input, the GSM configured to produce a linear output image from a non-linear input image provided by the signal input, wherein the linear output image is dithered using non-linear dithering to prevent contouring; and
a display device coupled to the GSM, the display device configured to display the linear output image.

17. The display system of claim 16, further comprising a display screen coupled to the display device, the display screen to permit viewing of projected linear output images.

18. The display system of claim 16, wherein the GSM comprises:
a de-gamma correction unit (DCU) coupled to the signal input, the DCU configured to remove a non-linear transformation present in images in a video signal from the signal input;
a gray shade unit (GSU) coupled to the DCU, the GSU configured to provide a first displayable gray shade with an intensity immediately above an intensity of a gray shade of a picture element in an image in the video signal and a second displayable gray shade with an intensity immediately below the intensity of the gray shade of the picture element; and
a dithering unit coupled to the GSU and the DCU, the dithering unit configured to compute a dithering percentage based upon the gray shade of the picture element and the first displayable gray shade and the second displayable gray shade and to select the first displayable gray shade or the second displayable gray shade based upon the dither percentage and a threshold value.

19. The display system of claim 16, wherein the display device is a spatial light modulator.

20. The display system of claim 16, wherein the display device is a digital micromirror device (DMD).
